(19) United States
(12) Patent Application Publication
(10) Pub. No.: US 2025/0326592 A1
(43) Pub. Date: Oct. 23, 2025

(54) SEPARATING STRUCTURE OF LASER ENGRAVING MACHINE

(71) Applicants: DINKLE ENTERPRISE CO., LTD., New Taipei City (TW); DINKLE ELECTRIC MACHINERY (CHINA) CO., LTD., KUNSHAN (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/638,646

(22) Filed: Apr. 17, 2024

(51) Int. Cl. B65G 59/02; B23K 26/362

(52) U.S. Cl. CPC B65G 59/023; B23K 26/362

(57) ABSTRACT

A separating structure of a laser engraving machine having a base seat, a transport mechanism, and a separating mechanism. The base seat has a waiting area for the workpieces being stacked and a processing area, the transport mechanism includes a driving source and a transfer member electrically connected to the driving source, the transfer member carries the workpieces, the separating mechanism is arranged on the waiting area and has two forks that are capable of switching between a standby position and a detached position. When the forks are located at the standby position, the workpieces are stacked on the transfer member. When the forks are located at the detached position, the forks carry the other workpieces above the workpiece carried by the transfer member, the driving source drives the transfer member to move to the processing area for processing the workpiece.

### BACKGROUND

### Technical Field

The present disclosure relates to an automation and semi-automation field, particularly to an automatic separating structure of a laser engraving machine.

### Description of Related Art

With the flourishing development of industry, many factories are gradually incorporating automatic equipment and semi-automatic equipment to effectively reduce labor, increase production capacity, and enhance yield. In the field of automation and semi-automation, it is often necessary to transport workpieces between different process stations. The workpieces are therefore transported in single or multiple quantities, such as tape, trays, or tray pallets. In addition, to minimize replenishment time, a waiting area is typically established before an initial station of the automatic or the semi-automatic equipment to store the workpieces awaiting processing, and sequentially transport the workpieces from the waiting area to a processing area for the required operations through a transport mechanism.

Traditional transport mechanisms commonly utilize a motor to drive pulleys to drive a conveyor belt such that the conveyor belt can transport the workpieces to the desired locations. Since the workpieces of the waiting area are commonly stacked for storage, a stopper is arranged between the waiting area and the processing area to block other workpieces above the bottom one during transportation such that only the bottom workpiece can transport to the processing area. However, this blocking method would generate excessive friction on the bottom workpiece to affect a transport path of the conveyor belt, so that it is necessitating to arrange additional positioning processes for the workpieces in the processing area.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to separate a bottom workpiece from other stacked workpieces on the separating structure of the laser engraving machine, so as to prevent the transport path from generating excessive friction during transportation.

To accomplish the aforementioned objective, the present disclosure provides a separating structure of a laser engraving machine, configured to separate one workpiece from a plurality of workpieces, the separating structure includes a base seat, a laser module, a transport mechanism, a plurality of limiting members, and a separating mechanism, the base seat has a waiting area and a processing area arranged along a longitudinal direction, the workpieces are stacked on the waiting area, the laser module is arranged on the base seat and located above the processing area, the transport mechanism is arranged on the base seat and includes a driving source and a transfer member, the driving source is electrically connected to the transfer member, the transfer member is configured to carry the workpieces, the limiting members are arranged on the waiting area, the workpieces are limited between the limiting members, the separating mechanism is arranged on the waiting area and has a pair of forks, the forks are respectively located on two sides of the workpieces and located between the transfer member and each of the limiting members, each of the forks is configured to switch between a standby position and a detached position, when the forks are located at the standby position, the workpieces are spacedly stacked on the transfer member, when the forks are located at the detached position, the forks are configured to carry other workpieces located above one of the workpieces carried by the transfer member, the driving source is configured to drive the transfer member and one of the workpieces carried by the transfer member to move from the waiting area to the processing area along the longitudinal direction for the laser module to perform laser processing.

Another aspect of the present disclosure provides that each of the forks has a pushing slope, a plurality of pushing slopes is arranged opposite to each other, when the forks move from the standby position to the detached position, the pushing slopes prop up other workpieces located above the one of the workpieces carried by the transfer member to separate other workpieces from the workpiece carried by the transfer member.

Another aspect of the present disclosure provides that the base seat includes a main board and a pair of supporting frames, the supporting frames are disposed parallelly to the longitudinal direction and spacedly arranged on the main board, each of the supporting frames has a runner defined thereon, the forks slidably insert in a plurality of the runners.

Another aspect of the present disclosure provides that the separating mechanism further includes a pair of drivers, each of the drivers is arranged corresponding to each of the forks and configured to drive each of the forks to switch between the standby position and the detached position.

Another aspect of the present disclosure provides that the separating mechanism further includes a pair of transmission rods and a pair of positioning columns, each of the forks has a limiting groove extending along the longitudinal direction, each of the drivers has a driving shaft, the driving shaft is fixed on a center of each of the transmission rods, each of the positioning columns is arranged on one end of each of the transmission rods and accommodated in a plurality of the limiting grooves, when the driving shafts rotate, each of the driving shafts is configured to drive each of the transmission rods to rotate to make each of the positioning columns drive each of the forks through each of the limiting grooves to slide in each of the runners.

Another aspect of the present disclosure provides that the separating mechanism further includes a pair of detection members and a pair of sensing assemblies, each of the detection members is arranged on each of the forks, each of the sensing assemblies is arranged corresponding to each of the forks and includes a start-point position sensor and an end-point position sensor, when each of the detection members is located in a detection range of the start-point position sensor, each of the drivers is stopped to make each of the forks be located at the standby position, when each of the detection members is located in a detection range of the end-point position sensor, each of the drivers is stopped to make each of the forks be located at the detached position.

Another aspect of the present disclosure provides that the limiting members includes a front baffle, a rear baffle, and a pair of side baffles, the front baffle and the rear baffle abut against two sides of the workpieces opposite to each other, the side baffles abut against other two sides of the workpieces opposite to each other.

Another aspect of the present disclosure provides that further includes an adjustment seat, the adjustment seat includes a pair of supporting stands, a connecting rod, and a slider, the supporting stands are arranged on the main board along the longitudinal direction and located between the supporting frames, two ends of the connecting rod are respectively fixed to the supporting stands, the slider is adapted to movably sheathe the connecting rod along the longitudinal direction, the rear baffle is arranged on the slider.

Another aspect of the present disclosure provides that the adjustment seat further includes a positioning rod, two ends of the positioning rod are respectively fixed to the supporting stands, the positioning rod is inserted to the slider.

Another aspect of the present disclosure provides that the adjustment seat further includes a supporting plate, the supporting plate is arranged on the supporting stand adjacent to the front baffle, a location of a top surface of the supporting plate is equal to or lower than a location of a top of the transfer member.

The separating structure of the laser engraving machine in the disclosure has the forks respectively arranged on two opposite sides of the waiting area, when the bottom workpiece needs to be separated from the workpieces stacked on the transfer member at intervals for being moved to the processing area, the forks are capable of moving from the standby position to the detached position to prop up the workpieces stacked above the workpiece carried by the transfer member to separate the bottom workpiece from the other workpieces. Further, the driving source drives the transfer member and the workpiece carried by the transfer member to move from the waiting area to the processing area along the longitudinal direction for the laser module to perform laser processing. Thus, the disadvantage of excessive friction generated by the workpieces in the conventional blocking way may be avoided.

### BRIEF DESCRIPTION OF THE DRAWINGS

FIG. 1 is a perspective appearance view of the present disclosure;

FIG. 2 is a partially perspective appearance view of the present disclosure;

FIG. 3 is a partially exploded view of the present disclosure;

FIG. 4 is an exploded view of the adjustment seat of the present disclosure;

FIG. 5 is a cross-sectional front view of the present disclosure at standby position;

FIG. 6 is a cross-sectional side view of the present disclosure at standby position;

FIG. 7 is a cross-sectional side view of the present disclosure carried smaller workpieces;

FIG. 8 is a partially cross-sectional side view of the present disclosure at standby position;

FIG. 9 is a cross-sectional front view of the present disclosure at detached position; and

FIG. 10 is a partially cross-sectional side view of the present disclosure at detached position.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

As used herein and not otherwise defined, the terms “substantially” and “approximately” are used to describe and describe small changes. When used in connection with an event or situation, the terms may include the precise moment at which the event or situation occurs, as well as the event or situation occurring to a close approximation. For example, when combined with a numerical value, the terms may include a range of variation equal to or less than ±10% of the numerical value, such as equal to or less than ±5%, equal to or less than ±4%, equal to or less than ±3%, equal to or less than ±2%, equal to or less than ±1%, equal to or less than ±0.5%, equal to or less than ±0.1%, or equal to or less than ±0.05%.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

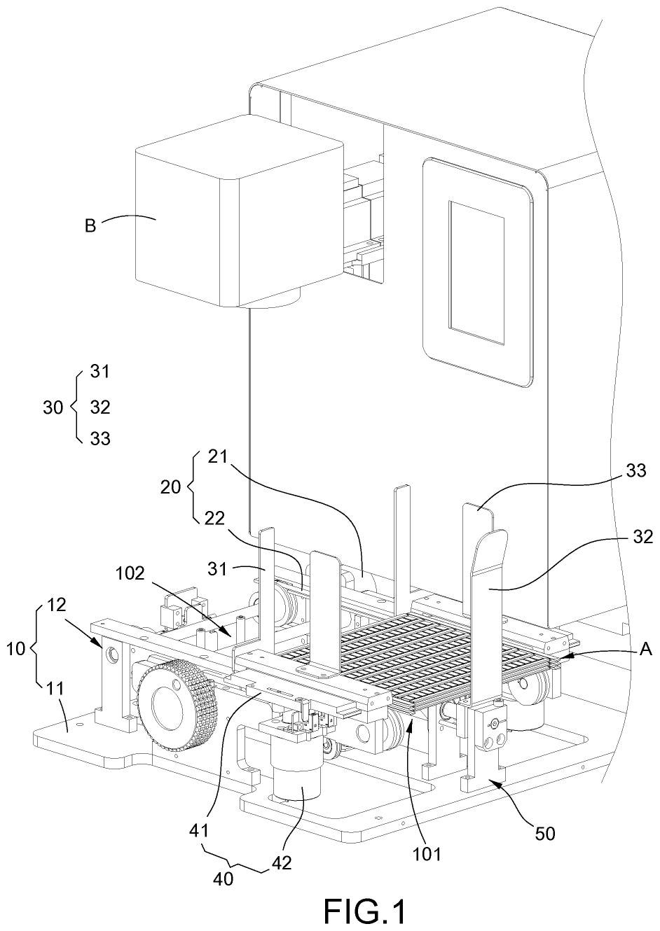

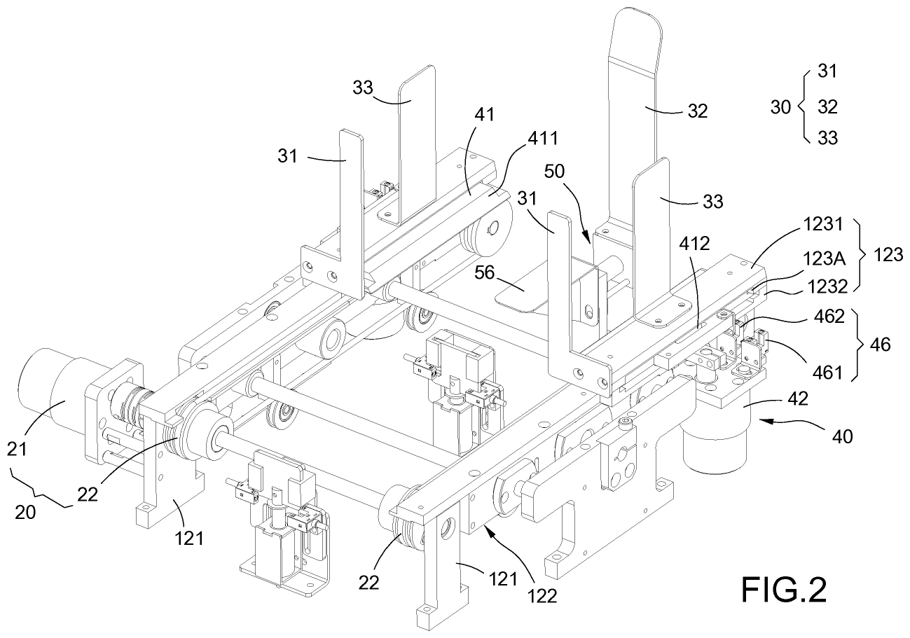

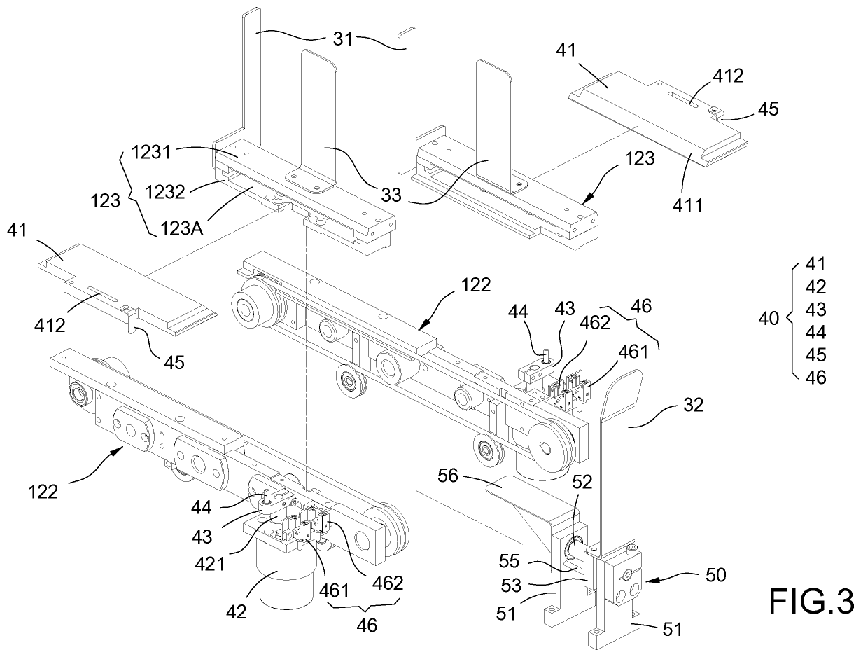

The present disclosure provides a separating structure of a laser engraving machine used to separate a workpiece A from a plurality of workpieces A. In the embodiment, each of the workpieces A is a rectangular plate-shaped structure formed by a plurality of semi-finished pieces or a plurality of finished pieces connected in a matrix, but the present disclosure does not limit to this embodiment. For example, each of the workpieces A may also be a rectangular plate-shaped structure formed by a semi-finished piece, a finished piece, or a tray carried a plurality of semi-finished pieces or a plurality of finished pieces, the present disclosure only requires the workpiece A to be a rectangular plate-shaped structure that may be stacked with the other workpieces A layer by layer. Please refer FIG. 1, FIG. 2 and FIG. 3, the separating structure of the laser engraving machine in the present disclosure mainly includes a base seat 10, a laser module B, a transport mechanism 20, a plurality of limiting members 30, and a separating mechanism 40.

The base seat 10 includes a main board 11 and a pair of supporting frames 12. The main board 11 has a waiting area 101 and a processing area 102 arranged along a longitudinal direction. In detail, the waiting area 101 and the processing area 102 are located between the supporting frames 12. The workpieces A are stacked sequentially on the waiting area 101 layer by layer. The main board 11 is a rectangular metal board, but the main board 11 is not limited to this specific shape and material. The supporting frames 12 are disposed parallelly to the longitudinal direction and arranged on the main board 11 at intervals. Each of the supporting frames 12 mainly includes a pair of base stands 121, a connecting assembly 122, and a fixing member 123. In detail, in each of the supporting frames 12, the base stands 121 are arranged on the main board 11 along the longitudinal direction, the connecting assembly 122 is connected and fixed to the base stands 121, the fixing member 123 is arranged on the connecting assembly 122 corresponding to the waiting area 101. Each of the fixing members 123 of each of the supporting frames 12 has a runner 123A. In detail, each of the fixing members 123 in the embodiment includes an upper plate 1231 and a lower plate 1232 stacked and assembled with each other, the runner 123A is formed between the upper plate 1231 and the lower plate 1232. Each of the fixing members 123 may also be in a one piece form and the runner 123A is formed therein. In the embodiment, an extended direction of each of the runners 123A is perpendicular to the longitudinal direction, but the present disclosure is not limit to this direction, the extended direction of each of the runners 123A only needs to be non-parallel to the longitudinal direction.

The laser module B is arranged on the base seat 10. The laser module B is located above the processing area 102. The laser module B is therefore performing a processing operation of laser marking to the workpiece A being moved to the processing area 102. The processing area 102 may also arrange other types of the processing modules, such as cutting, stamping, pin inserting, welding, assembling, testing, labeling . . . etc., the types of the processing modules may be modified and adjusted according to different needs.

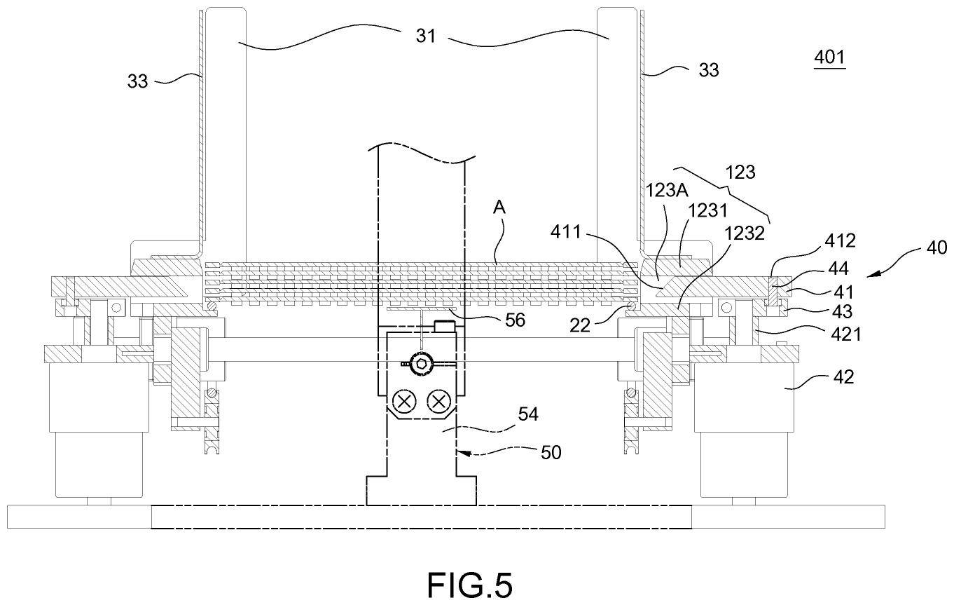

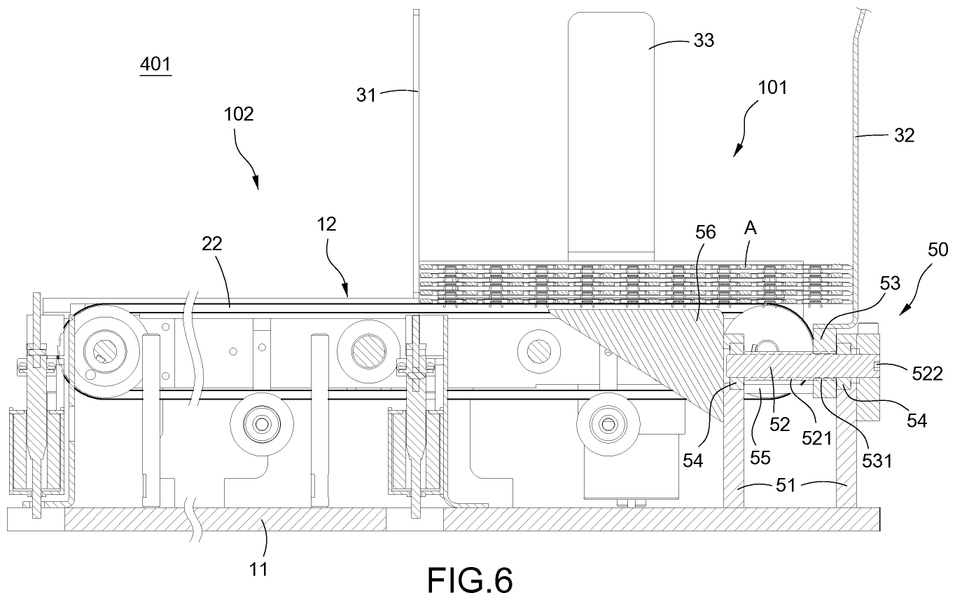

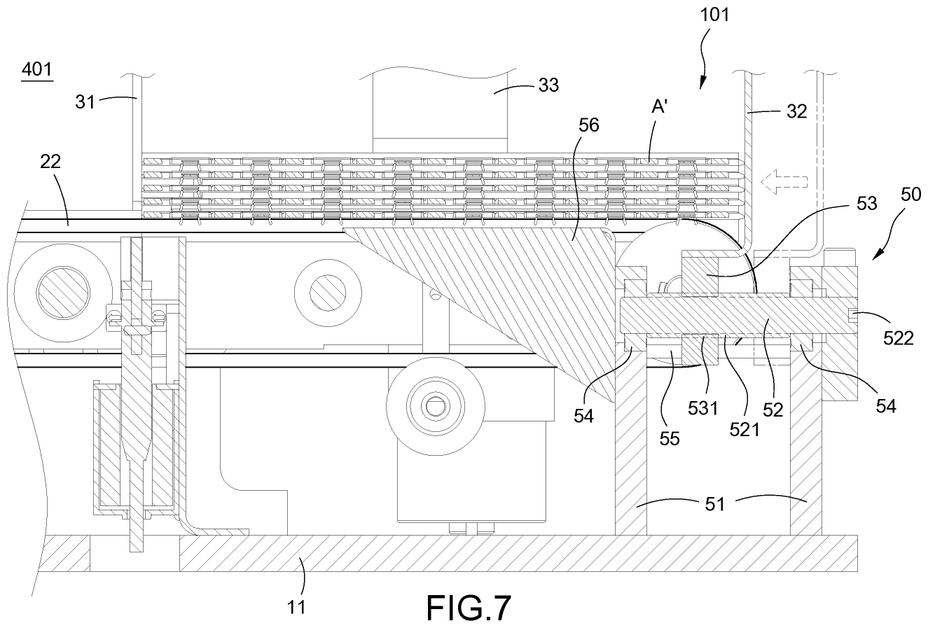

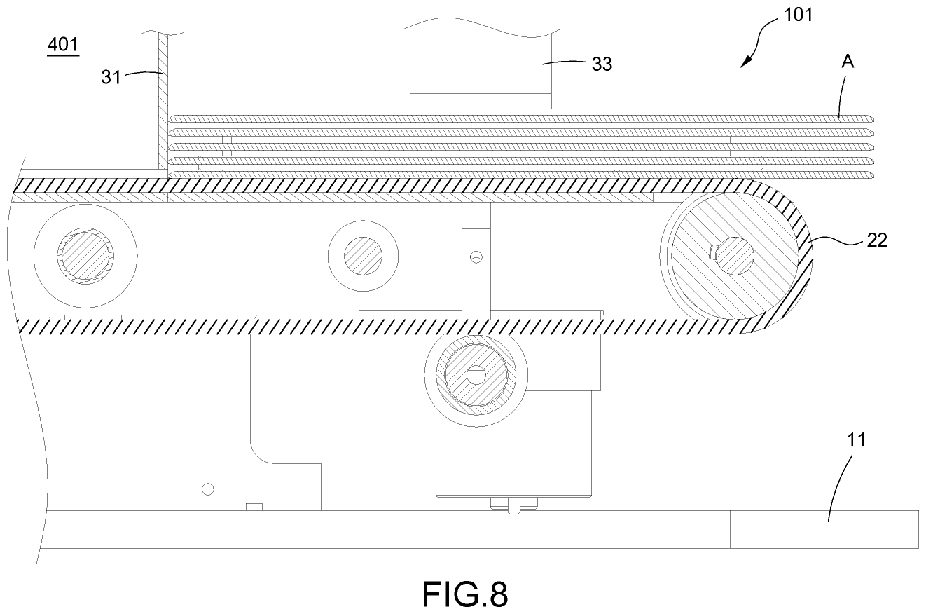

Please refer FIG. 1, FIG. 2, FIG. 3, FIG. 5, FIG. 6, FIG. 7, and FIG. 8. The transport mechanism 20 is arranged on the base seat 10. The transport mechanism 20 includes a driving source 21 and a transfer member 22. The driving source 21 is electrically connected to the transfer member 22. The transfer member 22 is configured to carry the workpieces A. In the embodiment, the driving source 21 is a stepper motor or a servo motor, the transfer member 22 is a pair of conveyor belts arranged respectively to each of the supporting frames 12. The stepper motor or servo motor drives the conveyor belts in a circular motion to transfer the workpiece A being carried through a plurality of pulleys (not labeled in figures) on the connecting assembly 122, but the present disclosure is not limit to this embodiment. For example, the driving source 21 may also be a linear motor, and the transfer member 22 may also be bearing a platform, so that the linear motor is capable of driving the bearing platform to move linearly to achieve a transport effect.

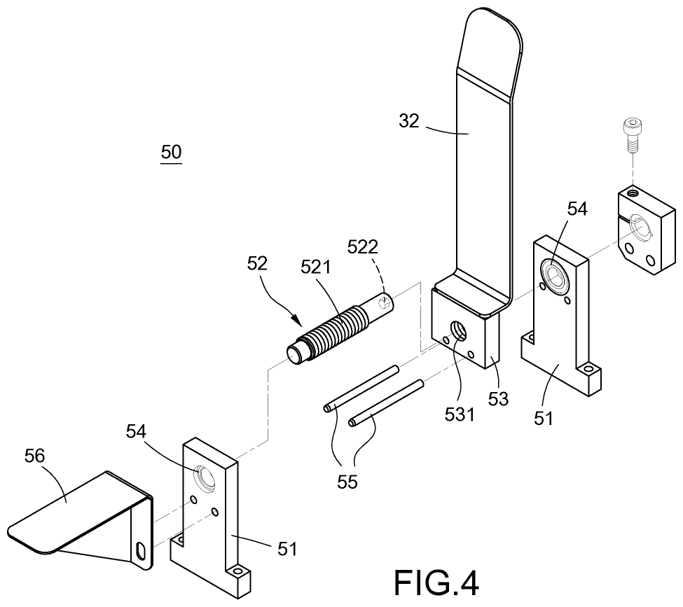

Please refer FIG. 1, FIG. 2, FIG. 3, FIG. 4, FIG. 5, and FIG. 6. The limiting members 30 are arranged on the waiting area 101. The workpieces A are limited between the limiting members 30, so as to limit the workpieces A neatly stacked in the waiting area 101. In detail, the limiting members 30 includes at least one front baffle 31, a rear baffle 32, and a pair of side baffles 33. The front baffle 31 and the rear baffle 32 respectively abut against two opposite sides (front side and rear side) of the workpieces A, the side baffles 33 respectively abut against other two opposite sides (left side and right side) of the workpieces A. In the embodiment, the number of the front baffle 31 is two, each of the front baffles 31 is arranged on a front side of each of the fixing members 123, and each of the side baffles 33 is arranged on an outer side of each of the fixing members 123, but the present disclosure is not limit to this embodiment.

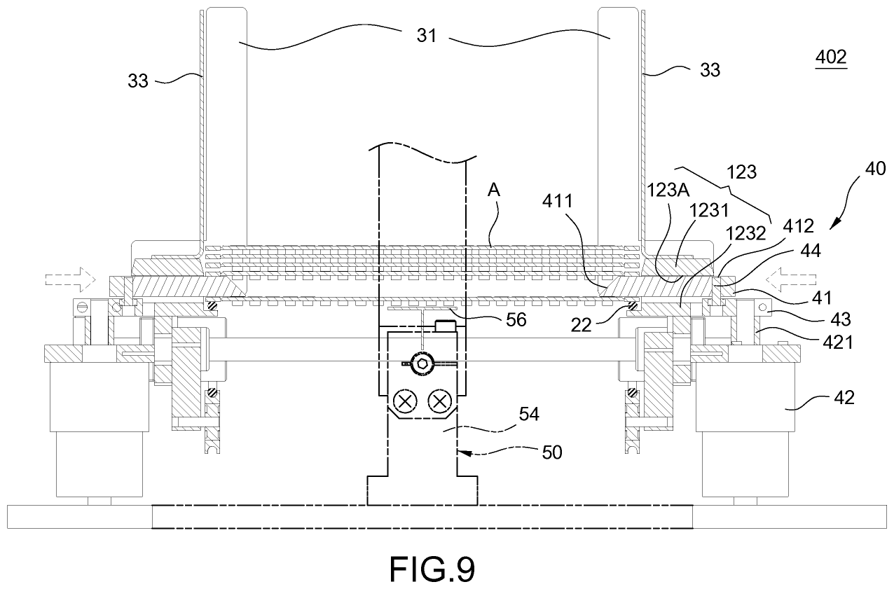

Please refer FIG. 1, FIG. 2, FIG. 3, FIG. 5, FIG. 6, FIG. 7, FIG. 8, and FIG. 9. The separating mechanism 40 is arranged on the waiting area 101. The separating mechanism 40 has a pair of forks 41. The forks 41 are respectively located on two sides of the workpieces A and located between the transfer member 22 and each of the limiting members 30. Each of the forks 41 is slidably inserted in each of the runners 123A to be switched between a standby position 401 and a detached position 402. In the embodiment, the separating mechanism 40 further includes a pair of drivers 42. Each of the drivers 42 is arranged corresponding to each of the forks 41 and drives each of the forks 41 to switch between the standby position 401 and the detached position 402, but the present disclosure is not limit to this. For example, the separating mechanism 40 may also utilize one driver 42 to drive the forks 41 at the same time, or share the driving source 21 with the transport mechanism 20 to drive the forks 41. Each of the forks 41 has a pushing slope 411. A plurality of pushing slopes 411 is arranged on opposite sides of the forks 41 correspondingly, and each of the pushing slopes 411 is downward and outward extended from a top of the fork 41 to a bottom of the corresponding fork 41.

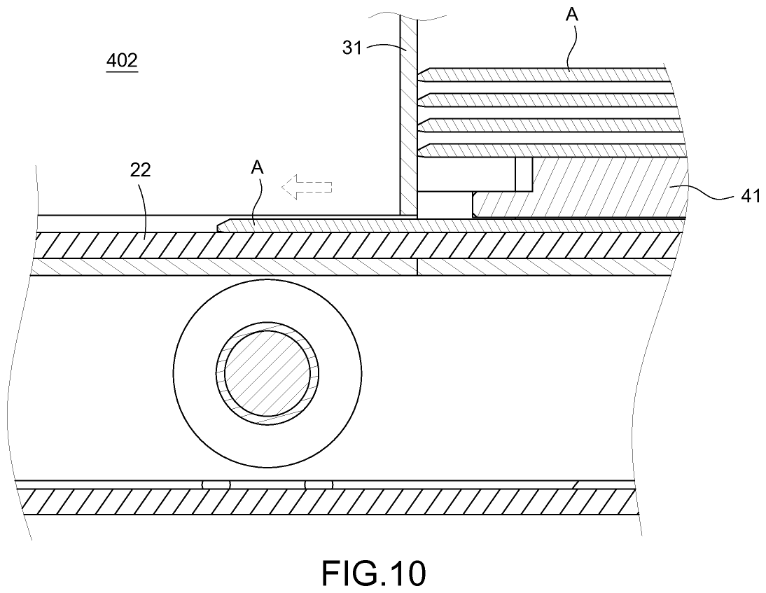

Please refer FIG. 5, FIG. 6, and FIG. 8. When the forks 41 are located at the standby position 401, the workpieces A are stacked on the transfer member 22 at intervals. Please refer FIG. 9 and FIG. 10. When the forks 41 move from the standby position 401 to the detached position 402, the pushing slopes 411 prop up other workpieces A located above one of the workpieces A carried by the transfer member 22 to separate other workpieces A from the workpiece A carried by the transfer member 22. That is when the forks 41 are located at the detached position 402, since the forks 41 are configured to carry other workpieces A located above the one of the workpieces A carried by the transfer member 22, the driving source 21 is capable of driving the transfer member 22 and one of the workpieces A carried by the transfer member 22 to move from the waiting area 101 to the processing area 102 along the longitudinal direction for the laser module B to perform laser processing on the separated workpiece A.

Details are provided as follows. Please refer FIG. 1, FIG. 2, FIG. 3, FIG. 5, FIG. 6, FIG. 7, FIG. 8, and FIG. 9. The separating mechanism 40 further includes a pair of transmission rods 43 and a pair of positioning columns 44. Each of the forks 41 has a limiting groove 412 extending along the longitudinal direction. In the embodiment, each of the drivers 42 is a servo motor or a stepper motor and has a driving draft 421, each of the driving shafts 421 is fixed at a center of each of the transmission rods 43, each of the positioning columns 44 is arranged at one end of each of the transmission rods 43 and accommodated in each of the limiting grooves 412 of each of the forks 41. When each of the driving shafts 421 of each of the drives 42 rotates, each of the driving shafts 421 drives each of the transmission rods 43 to rotate with the corresponding drive shaft 421 as an axis, so that each of the positioning columns 44 located at an end of each of the transmission rods 43 is capable of driving each of the forks 41 to slide in each of the runners 123A through each of the limiting grooves 412 so as to switch the forks 41 between the standby position 401 and the detached position 402. However, the present disclosure is not limit to above disclosure. For example, the driver 42 may also be a linear actuator, such as electric actuator or pneumatic cylinder to directly drive the forks 41. The reason why using the servo motor or the stepper motor in the embodiment cooperates with the transmission rod 43 and the positioning column 44 is to reduce a lateral space and reduce a space occupied by the separating structure of laser engraving machine.

More particularly, each of the drivers 42 in the embodiment is the stepper motor, and the separating mechanism 40 further includes a pair of detection members 45 and a pair of sensing assemblies 46. Each of the detection members 45 is arranged on each of the forks 41 so that each of the detection members 45 is capable of being switched between the standby position 401 and the detached position 402 with each of the forks 41. Each of the sensing assemblies 46 is arranged corresponding to each of the forks 41. Each of the sensing assemblies 46 includes a start-point position sensor 461 and an end-point position sensor 462. The start-point position sensor 461 and the end-point position sensor 462 are respectively and electrically connected to a controller (not shown in figures) and the corresponding driver 42. When each of the detection members 45 moves with each of the forks 41 to located at a detection range of each of the start-point position sensors 461, each of the start-point position sensors 461 sends a signal to controller so that each of the drivers 42 stops operating to stop each of the forks 41 at the standby position 401. When each of the detection members 45 moves with each of the forks 41 to a detection range of each of the end-point position sensors 462, each of the end-point position sensors 462 sends a signal to controller so that each of the drivers 42 stops operating to stop each of the forks 41 at the detached position 402. That is, through detecting by the start-point position sensors 461 and the end-point position sensors 462, the standby position 401 and the detached position 402 of the forks 41 may be effectively controlled so as to prevent the forks 41 from moving excessively to cause collision, interference, and damage to the separating mechanism 40.

Details are provided as follows. Please refer FIG. 1, FIG. 2, FIG. 3, FIG. 4, FIG. 6, and FIG. 7. The separating structure of laser engraving machine of the present disclosure further includes an adjustment seat 50. The adjustment seat 50 mainly includes a pair of supporting stands 51, a connecting rod 52, and a slider 53. The supporting stands 51 are arranged on the main board 11 along the longitudinal direction and located between the supporting frames 12. Two ends of the connecting rod 52 are respectively fixed to the supporting stands 51. The slider 53 sheathes the connecting rod 52 and is capable of sliding along the longitudinal direction. The rear baffle 32 is arranged on the slider 53 so as to slide along the longitudinal direction with the slider 53 to adjust position, so that the limiting members 30 may limit and accommodate the other workpieces A with different longitudinal lengths. For example, please refer again to FIG. 6. When a longitudinal length of the workpiece A is larger, a user or an operator may adjust the slider 53 backward such that the rear baffle 32 abuts against and limits a backside of the workpiece A. Then please refer again to FIG. 7. When a longitudinal length of another workpiece A′ is smaller, the user or the operator may adjust the slider 53 forward such that the rear baffle 32 abuts against and limits the backside of the workpiece A′.

In detail, an external thread 521 is formed on an outer edge of the connecting rod 52 between the supporting stands 51, an inner thread 531 screwed with the external thread 521 is formed in the slider 53. The connecting rod 52 is rotatably arranged on the supporting stands 51 through a pair of bearing 54, and an end of the connecting rod 52 has a wrench hole 522. When the user or the operator need to adjust a position of the slider 53, the user or the operator only needs to connect (or insert) a wrench (not shown in figures) with the wrench hole 522 of the end of the connecting rod 52 so as to drive the connecting rod 52 to rotate by the wrench, so that the slider 53 is capable of moving forward or backward relative to the connecting rod 52 to adjust the position. However, the present disclosure is not limit to this embodiment. For example, the outer edge of the connecting rod 52 may also be smooth surface so that the user or the operator may directly push or pull the slider 53 to adjust the position of the slider 53.

In addition, in order to prevent the slider 53 from rotating relative to the connecting rod 52, the adjustment seat 50 in the embodiment further includes at least one positioning rod 55. Two ends of the positioning rod 55 are respectively fixed to the supporting stands 51. The positioning rod 55 penetrates the slider 53. Since the connecting rod 52 and the positioning rod 55 penetrate the slider 53 at the same time, the slider 53 cannot rotate relative to the connecting rod 52. In the embodiment, the number of the positioning rod 55 is two, but the present disclosure is not limit to this number. The adjustment seat 50 further includes a supporting plate 56. The supporting plate 56 is arranged on the supporting stand 51 adjacent to the front baffle 31. A location (or surface level) of the top surface of the supporting plate 56 is substantially equal to or lower than a location (or surface level) of the top of the transfer member 22, that is the top surface of the supporting plate 56 is not located at the level higher than the level of the top of the transfer member 22, so that the supporting plate 56 serves as an auxiliary support to prevent the workpiece A from falling directly when the workpiece A accidentally detaches from the transfer member 22.

The separating structure of the laser engraving machine in the disclosure has the forks 41 respectively arranged on two opposite sides of the waiting area 101, when the bottom workpiece A needs to be separated from the workpieces A stacked on the transfer member 22 at intervals for being moved to the processing area 102, the forks 41 are capable of moving from the standby position 401 to the detached position 402 to prop up the workpieces A stacked above the workpiece A carried by the transfer member 22 to separate the bottom workpiece A from the other workpieces A. Further, the driving source 21 drives the transfer member 22 and the workpiece A carried by the transfer member 22 to move from the waiting area 101 to the processing area 102 along the longitudinal direction for the laser module B to perform laser processing. Thus, the disadvantage of excessive friction generated by the workpieces A in the conventional blocking way may be avoided.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A separating structure of a laser engraving machine, configured to separate one workpiece from a plurality of workpieces, the separating structure comprising:
a base seat, comprising a waiting area and a processing area arranged along a longitudinal direction, wherein the workpieces are stacked on the waiting area;
a laser module, arranged on the base seat and located above the processing area;
a transport mechanism, arranged on the base seat, comprising a driving source and a transfer member, the driving source electrically connected to the transfer member, and the transfer member configured to carry the workpieces;
a plurality of limiting members, arranged on the waiting area, wherein the workpieces are limited between the limiting members; and
a separating mechanism, arranged on the waiting area, comprising a pair of forks, the forks respectively located on two sides of the workpieces and located between the transfer member and each of the limiting members, and each of the forks configured to switch between a standby position and a detached position;
wherein when the forks are located at the standby position, the workpieces are spacedly stacked on the transfer member;
wherein when the forks are located at the detached position, the forks are configured to carry other workpieces located above one of the workpieces carried by the transfer member, the driving source is configured to drive the transfer member and the one of the workpieces carried by the transfer member to move from the waiting area to the processing area along the longitudinal direction for the laser module to perform laser processing.

2. The separating structure according to claim 1, wherein each of the forks comprising a pushing slope, a plurality of pushing slopes is arranged opposite to each other, when the forks move from the standby position to the detached position, the pushing slopes prop up other workpieces located above the one of the workpieces carried by the transfer member to separate other workpieces from the one of the workpieces carried by the transfer member.

3. The separating structure according to claim 1, wherein the base seat comprises a main board and a pair of supporting frames, the supporting frames are disposed parallelly to the longitudinal direction and spacedly arranged on the main board, each of the supporting frames comprises a runner defined thereon, the forks slidably inserts in a plurality of the runners.

4. The separating structure according to claim 3, wherein the separating mechanism further comprises a pair of drivers, each of the drivers is arranged corresponding to each of the forks and configured to drive each of the forks to switch between the standby position and the detached position.

5. The separating structure according to claim 4, wherein the separating mechanism further comprises a pair of transmission rods and a pair of positioning columns, each of the forks comprises a limiting groove extending along the longitudinal direction, each of the drivers comprises a driving shaft, the driving shaft is fixed on a center of each of the transmission rods, each of the positioning columns is arranged on one end of each of the transmission rods and accommodated in a plurality of the limiting grooves, when the driving shafts rotate, each of the driving shafts is configured to drive each of the transmission rods to rotate to make each of the positioning columns drive each of the forks through each of the limiting grooves to slide in each of the runners.

6. The separating structure according to claim 4, wherein the separating mechanism further comprises a pair of detection members and a pair of sensing assemblies, each of the detection members is arranged on each of the forks, each of the sensing assemblies is arranged corresponding to each of the forks and comprises a start-point position sensor and an end-point position sensor, when each of the detection members is located in a detection range of the start-point position sensor, each of the drivers is stopped to make each of the forks be located at the standby position, when each of the detection members is located in a detection range of the end-point position sensor, each of the drivers is stopped to make each of the forks be located at the detached position.

7. The separating structure according to claim 3, wherein the limiting members comprises a front baffle, a rear baffle, and a pair of side baffles, the front baffle and the rear baffle abut against two sides of the workpieces opposite to each other, the side baffles abut against other two sides of the workpieces opposite to each other.

8. The separating structure according to claim 7, further comprising an adjustment seat, the adjustment seat comprises a pair of supporting stands, a connecting rod, and a slider, the supporting stands are arranged on the main board along the longitudinal direction and located between the supporting frames, two ends of the connecting rod are respectively fixed to the supporting stands, the slider is adapted to movably sheathe the connecting rod along the longitudinal direction, and the rear baffle is arranged on the slider.

9. The separating structure according to claim 8, wherein the adjustment seat further comprises a positioning rod, two ends of the positioning rod are respectively fixed to the supporting stands, and the positioning rod is inserted to the slider.

10. The separating structure according to claim 8, wherein the adjustment seat further comprises a supporting plate, the supporting plate is arranged on the supporting stand adjacent to the front baffle, and a location of a top surface of the supporting plate is equal to or lower than a location of a top of the transfer member.
